(19) United States
(12) Patent Application Publication
(10) Pub. No.: US 2007/0006244 A1
(43) Pub. Date: Jan. 4, 2007

(54) Storage device assembly

(75) Inventor: David Huang, Wugu Township (TW)

Correspondence Address: HDSL, 4331 STEVENS BATTLE LANE, FAIRFAX, VA, 22033, US

(73) Assignee: Data-Tec. Technology Co., Ltd.

(21) Appl. No.: 11/168,473

(22) Filed: Jun. 29, 2005

(51) Int. Cl. G03B 5/06; G03B 17/04; G11B 33/02

(52) U.S. Cl. 720/657

(57) ABSTRACT

A storage device assembly includes a case unit, a storage unit and a fixing unit. The case unit includes a first housing and a second housing. The storage mounted in the case includes a connecting hole formed on a side. The fixing unit formed on the first housing includes a flexible stand portion and a protrusion formed on the stand portion to be fixedly secured to the connecting hole.

### BACKGROUND OF THE INVENTION

1. Field of Invention

The present invention relates in general to a storage device assembly, and more particularly, to a storage device including a case unit for a storage unit to be conveniently and rapidly attached thereto or detached therefrom.

2. Related Art

Conventional storage device of a disk drive, such as a hard drive or an optical drive includes a case unit 4. The case unit 4 includes an upper housing 41 and a lower housing 42 mounted together by multiple screws 43. The disk drive 5 is fixedly located on the lower housing 42 with another multiple screws 44 respectively secured to the fixing holes 51 on both sides thereof. As such, a storage device assembly is complete.

However, it is inconvenient and lousy for the disk drive 5 to be mounted to the case unit 4 in way of screws 43, 44. Besides, it may cause damage to the disk drive 5 when the screws 44 are not appropriately fixed to holes 51.

### SUMMARY OF THE INVENTION

Accordingly, the present invention is to provide a storage device including a case unit for a storage unit to be conveniently and rapidly attached thereto or detached therefrom.

The storage device of the present invention includes a case unit, a storage unit and a plurality of fixing unit. The case unit includes a first housing and a second housing. The storage unit mounted in the case includes a plurality of connecting holes formed on two opposite sides. The plurality of fixing units are formed on the first housing. In one preferred embodiment, the fixing unit includes a flexible stand portion and a protrusion formed on the stand portion. In another preferred embodiment, the first housing has only two sidewalls to provide flexibility and the fixing units are directly formed on both sidewalls. The protrusion is fixedly secured to the connecting hole so that the storage unit can be fixedly mounted in the case unit.

### BRIEF DESCRIPTION OF THE DRAWINGS

The present invention will become more fully understood from the detailed description given hereinbelow illustration only, and thus are not limitative of the present invention, and wherein:

FIG. 1 shows an exploded view of a conventional disk drive;

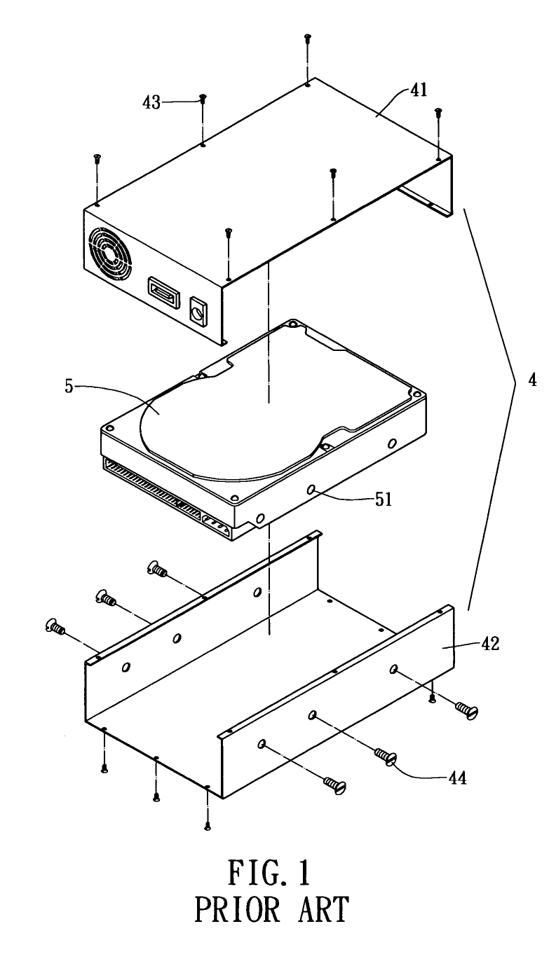

FIG. 2 shows an exploded view of a storage device assembly according to the present invention;

FIG. 3 shows a cross sectional view of the storage device;

FIG. 4 shows another preferred embodiment of the present invention; and

FIG. 5 shows still another preferred embodiment of the present invention.

### DETAILED DESCRIPTION OF THE INVENTION

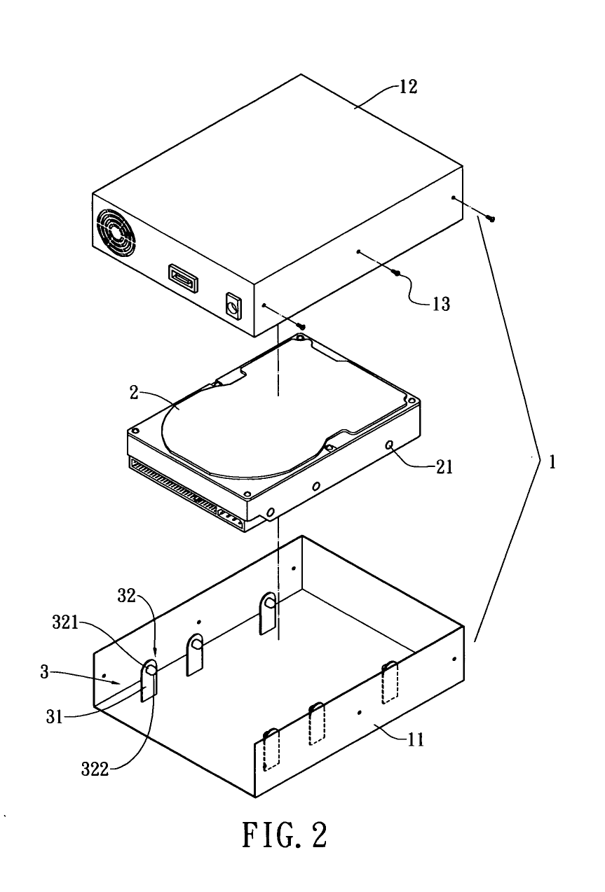

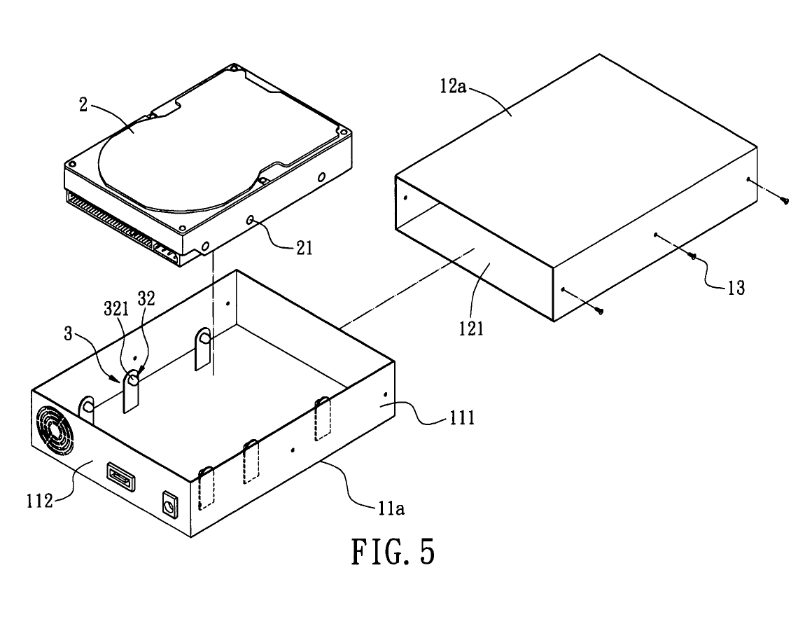

Referring to FIGS. 2 and 5, a storage device assembly includes a case unit 1, a storage unit 2 and a plurality of fixing units 3. The storage unit 2 can be conveniently attached to or detached from the case unit 1 by the fixing units 3 of the present invention.

The case unit 1 includes a first housing 11 and a second housing 12. A plurality of screwing elements 13 are used to mount the first and the second housing 11 and 12 to each other.

The storage unit 2 is a disk drive including a hard drive or an optical drive. A plurality of connecting holes 21 are formed on two opposite sides of the storage unit 2 for installing the storage unit 2 in the case unit 1.

Each fixing unit 3 is formed on the first housing 11 and corresponds to one connecting hole 21 when the storage unit 2 is located on the first housing 11. The fixing unit 3 includes a stand portion 31 which is flexible and elastic, and a protrusion 32 formed on the stand portion 31. The protrusion 32 includes an extension 321 extending from the stand portion 31 and a curve tip 322.

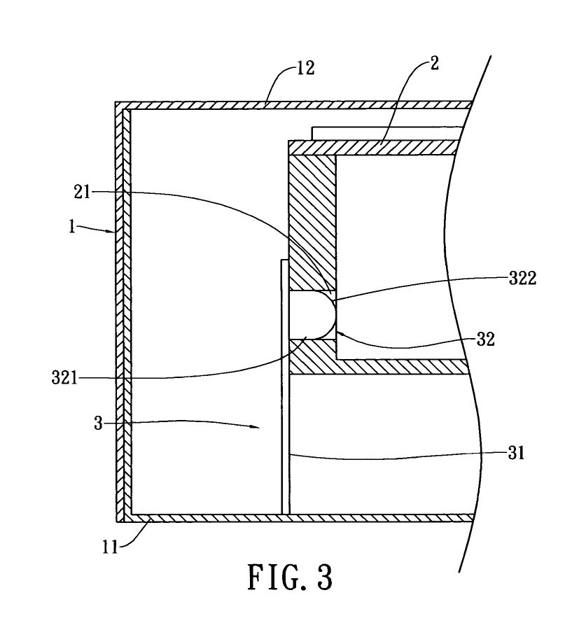

In one embodiment, as shown in FIGS. 2 and 3, when the storage unit 2 is installed into the first housing 11, the fixing unit 3 can be easily and rapidly secured to the connecting hole 21 under the flexibility of the stand portion 31. Moreover, guiding by the curve tip 322 and strained fitness of the extension 321 with the size of the connecting hole 21, the storage unit 2 can be fixedly mounted in the case unit 1.

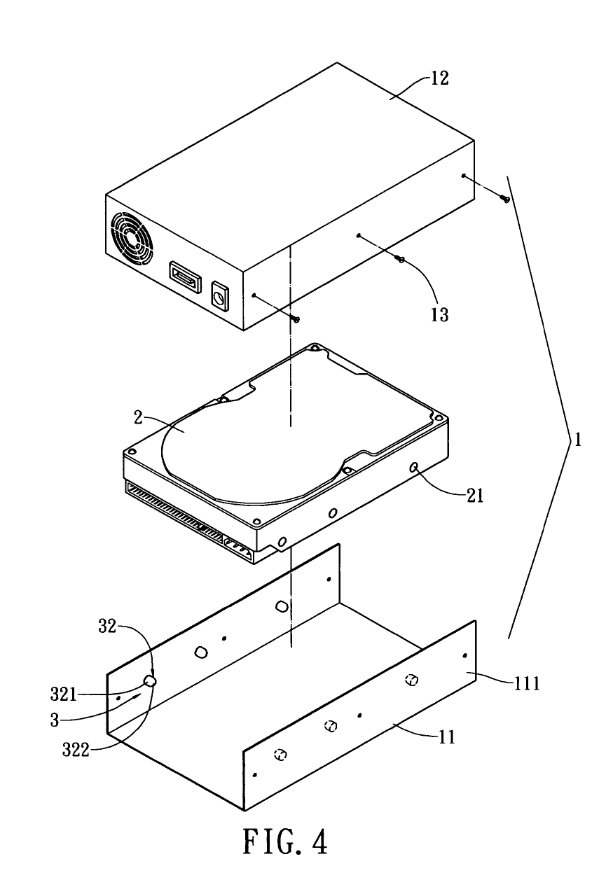

In another embodiment, as shown in FIG. 4, the fixing unit 3 is directly formed on each sidewall 111 of the first housing 11. Compared to FIG. 2, the first housing 11 has only two sidewalls 111; therefore, the protrusion 32 can be easily and rapidly secured to the connecting hole 21 under the flexibility of the sidewall 111.

Still in another embodiment, as shown in FIG. 5, the case unit 1 is combined in different way. The second housing 12 is no more in form of a lid to cover on the first housing 11. Instead, the first housing 11 is in form of a drawer to be put inside the second housing 12.

The invention being thus described, it will be obvious that the same may be varied in many ways. Such variations are not to be regarded as a departure from the spirit and scope of the invention, and all such modifications as would be obvious to one skilled in the art are intended to be included within the scope of the following claims.

What is claimed is:

1. A storage device comprising:
a case unit including a first housing and a second housing;
a storage unit mounted in the case, including a connecting hole formed on a side; and
a fixing unit formed on the first housing, including a flexible stand portion and a protrusion formed on the stand portion to be fixedly secured to the connecting hole.

2. The storage device of claim 1, further comprising a plurality of screwing elements to mount the first and the second housing to each other.

3. The storage device of claim 1, wherein the storage unit is a disk drive.

4. The storage device of claim 3, wherein the disk drive is a hard drive or an optical drive.

5. The storage device of claim 4, wherein the storage unit includes a plurality of connecting hole formed on two opposite sides.

6. The storage device of claim 1, wherein the protrusion includes an extension extending from the stand portion and a curve tip.

7. A storage device comprising:
a case unit including a first housing with only two sidewalls and a second housing;
a storage unit mounted in the case, including a plurality of connecting holes formed on two opposite sides; and
a plurality of fixing units formed on both the sidewalls, each fixing unit including a protrusion to be fixedly secured to the connecting hole.

8. The storage device of claim 7, wherein the protrusion includes an extension and a curve tip.
